(19) United States
(12) Patent Application Publication
(10) Pub. No.: US 2012/0317339 A1
(43) Pub. Date: Dec. 13, 2012

(54) SYSTEM AND METHOD FOR CACHING DATA IN MEMORY AND ON DISK

(75) Inventors: Thomas R. Gissel, Apex, NC (US); Avraham Leff, Spring Valley, NY (US); Benjamin Michael Parees, Durham, NC (US); James Thomas Rayfield, Ridgefield, CT (US)

(73) Assignee: INTERNATIONAL BUSINESS MACHINES CORPORATION, Armonk, NY (US)

(21) Appl. No.: 13/159,119

(22) Filed: Jun. 13, 2011

(51) Int. Cl. G06F 12/08; G06F 12/00

(52) U.S. Cl. 711/103; 711/118; 711/E12.017; 711/E12.008

(57) ABSTRACT

A cache is configured as a hybrid disk-overflow system in which data sets generated by applications running in a distributed computing system are stored in a fast access memory portion of cache, e.g., in random access memory and are moved to a slower access memory portion of cache, e.g., persistent durable memory such as a solid state disk. Each data set includes application-defined key data and bulk data. The bulk data are moved to slab-allocated slower access memory while the key data are maintained in fast access memory. A pointer to the location within the slower access memory containing the bulk data is stored in the fast access memory in association with the key data. Applications call data sets within the cache using the key data, and the pointers facilitate access, management and manipulation of the associated bulk data. Access, management and manipulation occur asynchronously with the application calls.

### FIELD OF THE INVENTION

The present invention relates to data caching.

### BACKGROUND OF THE INVENTION

Caching appliances used in computing systems, for example, the Websphere® DataPower XC10, which is commercially available from the International Business Machines Corporation of Armonk, N.Y., use large solid state disks (SSD) as a main source of storage capacity for cached values. These appliances also include a quantity of random access memory (RAM). These appliances are used to provide storage for cache values generated, for example, by applications running in a distributed computing environment with the goal of providing extremely fast access to the cached values. For example, a Derby database can be provided on the SSD, and all cached values are stored in this database. The RAM is allocated to the Derby database for caching the database row/index content.

The use of a Derby database and RAM allocation for row/index content, however, provide atomicity, consistency, isolation and durability (ACID) level guarantees that were not necessary for a cache. If a cache appliance fails, loss of cached data is acceptable. Maintaining ACID level guarantees requires significant overhead in the form of transaction logs and all items are written to disk even if the entire cache dataset would fit in the memory, i.e., RAM, of the caching appliance. In addition, data are cached in the form of completely arbitrary binary values that can range from a few bytes to a few megabytes. However, optimizing a database for variable sized rows is difficult. Moreover, using RAM as a cache for Derby caused the duplication of content between the RAM and the SSD, wasting cache appliance capacity.

One attempt at overcoming these problems with conventional cache appliance operation utilized a “diskoverflow” feature. This solution required that disk locations be looked up from the disk, i.e., a traditional file allocation table type arrangement. This places a significant limitation on the disk storage structure, yielding less efficient disk operation and precluding certain asynchronous data access optimizations.

System and methods for operating cache appliances are desired that would yield performance in the cache appliance that is as fast as if all data were stored in RAM as long as the total size of the data set can fit in the available RAM. Therefore, no disk access would occur until the memory capacity was exceeded. In addition, these systems and methods would eliminate the redundancy of data held between the RAM and the SSD.

### SUMMARY OF THE INVENTION

Systems and methods in accordance with exemplary embodiments of the present invention are directed to a cache configured as a hybrid disk-overflow system in which data sets generated by applications running in a distributed computing system are stored in a fast access memory portion of cache, e.g., in random access memory (RAM) and are moved to a slower access memory portion of cache, e.g., persistent durable memory such as a solid state disk (SSD). Each data set includes application-defined key data, or other metadata, and the bulk or body portion data. The bulk data only are moved to the slower access memory portion while the key data are maintained in the fast access memory portion. A pointer is created for the location within the slower access memory portion containing the bulk data, and this pointer is stored in the fast access memory portion in association with the key data. Applications call data sets within the cache using the key data, and the pointers facilitate access, management and manipulation of the associated bulk data. This access, management and manipulation, however, can occur asynchronously with the application call to the key data.

### BRIEF DESCRIPTION OF THE DRAWINGS

FIG. 1 is a schematic representation of an embodiment of a computing system for use with the caching system in accordance with the present invention;

FIG. 2 is a schematic representation of an embodiment of the caching system of the present invention; and

FIG. 3 is a flow chart illustration an embodiment of a method for caching data in accordance with the present invention.

### DETAILED DESCRIPTION

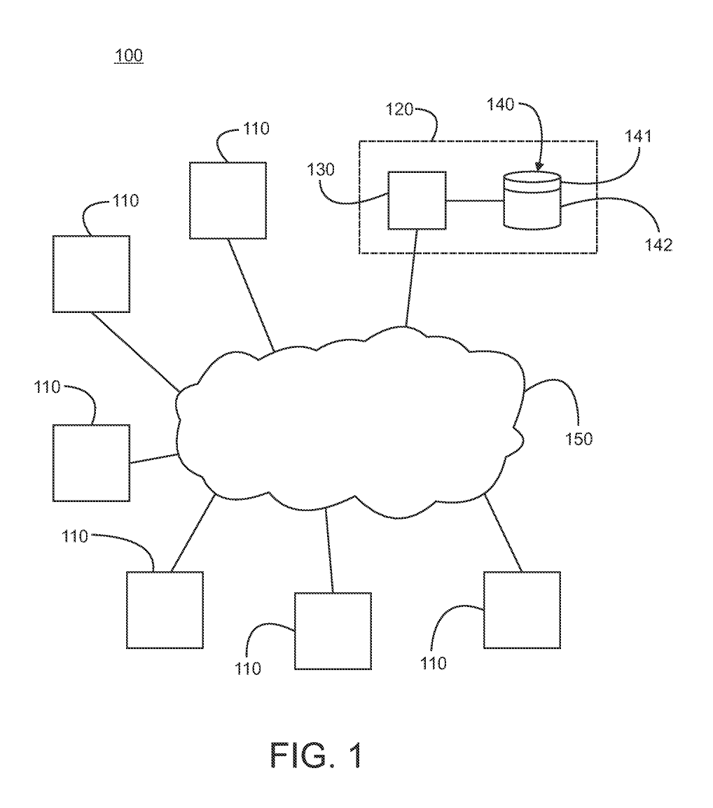

Exemplary embodiments of systems and methods in accordance with the present invention provide for the caching of data from applications running in a computing system for example a distributed computing system. Referring to FIG. 1, a distributed computing system environment 100 for use with the systems and methods for caching data in accordance with the present invention is illustrated. The computing system can be a distributed computing system operating in one or more domains. Suitable distributed computing systems are known and available in the art. Included in the computing system is a plurality of nodes 110. These nodes support the instantiation and execution of one or more distributed computer software applications running in the distributed computing system. An entire application can be executing on a given node or the application can be distributed among two or more of the nodes. All of the nodes, and therefore, the applications and application portions executing on those nodes are in communication through one or more networks 150, including side area networks and local area networks.

Also included within and in communication with the distributed computing system environment is a system for caching data 120 in accordance with the present invention. The system for caching data is also in communication with the nodes in the distributed computing system across one or more networks 150. The system for caching data includes a data placement manager 130 and a cache 140. The data placement manager can be integrated into the same appliance containing the cache or can be provided in a separate appliance or computer. The data placement manager is configured to manage the storage and modification of data sets in the cache. Therefore, the cache functions as a cache for the entire distributed computing system and for all of the applications executing within this environment. Suitable caches or cache appliances are known and available in the art. In one embodiment, the cache is the Websphere® DataPower XC10 or any other similar of suitable cache or cache appliance.

The cache is sized to have a storage capacity that is suitable for the number and size of data sets that are generated by the applications and that require storage in the cache. In one embodiment, the cache is at least 100 GB. For example, the cache can have total storage capacity of about 240 GB. The cache includes a fast access memory portion 141 and a slow access memory portion 142. As used herein, the fast access memory portion provides for faster access to stored data and includes volatile memory such as random access memory (RAM). Fast access memory is preferred by applications for cache, because the access time, i.e., for reads and writes, to this memory is faster. The slow access memory portion provides for efficient storage of large amounts of data; however, access to data contained within the slow access memory portion is slower than the fast access memory portion. Suitable slow access memory portions include persistent durable storage types including a solid state disk (SSD). The total storage capacity of the cache is allocated between the two memory portions. However, this allocation is not even, and most of the storage capacity is located in the slow access memory portion. In one embodiment, the ratio of storage capacity between the fast access memory portion to the slow access memory portion is about 1 to about 5.

The cache holds data sets that are defined and generated by the applications running in the computing system. The data placement manager provides the interface between the cache and each application. In accordance with an exemplary embodiment of the present invention, the data placement manager handles a plurality of data sets stored in the cache. Preferably, all of the data sets are stored in the fast access memory portion of the cache. When the storage capacity of the fast access memory portion of the cache is reached, the slow access memory portion of the cache is used as overflow storage. The system for caching data in accordance with embodiments of the present invention, however, maintains an appearance and functionality to all of the applications generating the data sets that these data sets are contained within the fast access memory portion. This appearance and functionality is facilitated by the data placement manager by controlling where and how the data sets are divided and stored between the fast and slow access memory portions.

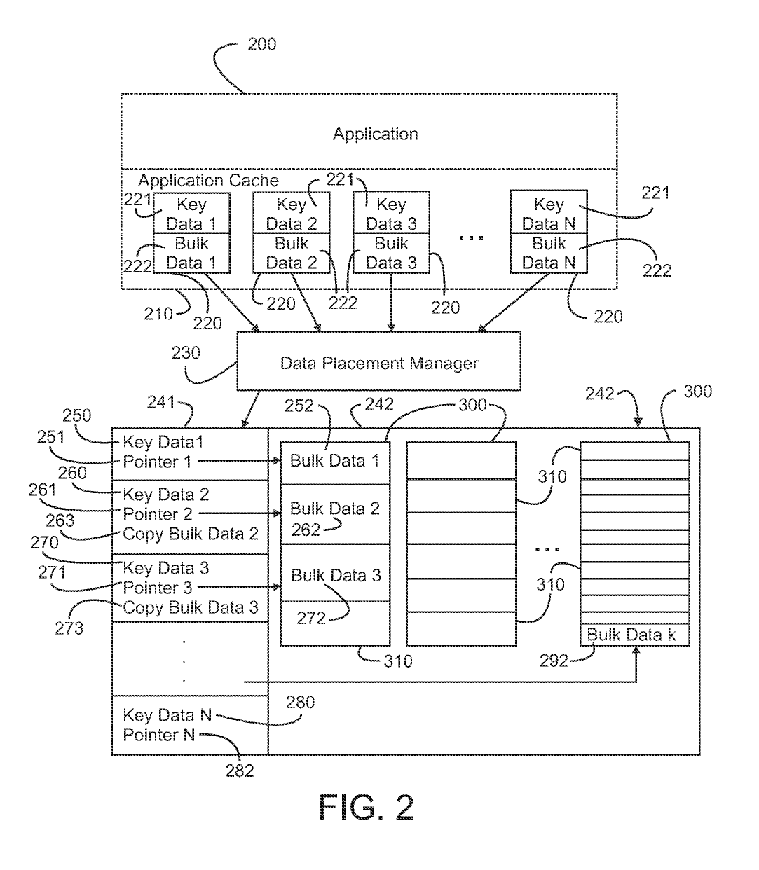

Referring to FIG. 2, a given application 200 running in the distributed computing system generates a plurality of data sets 220. In one embodiment, these data sets are initially generated and stored in a local application cache 210 associated with and directly controlled by the application. Although illustrated as a single application generating a plurality of data sets, the plurality of data sets can be provided by a plurality of separate and distinct applications running in the distributed computing environment. In one embodiment, each one of a plurality of distributed applications generates a single data set that is communicated through the data placement manager 230 for storage in the cache 240.

Each data set 220 includes key data 221 and bulk data 222. The key data are used by the application generating the data set to identify, locate, access or call the data set. For example, the key data for a customer, client or patient data set is the name of the customer. This could include aliases, nicknames, or portions of the names. The key data can also include the address of the individual or the company for which the individual works. In one embodiment, the key data are meta-data associated with the data set or computer readable files containing the data set. For purposes of accessing and managing the data set, the key data represents a higher value data. Therefore, these data need to be accessed quickly. The bulk data, which represent a larger amount of data than the key data, contains the actual content of the data set, for example, the customer or client records. Although the bulk data are important to the applications and are used by the applications, for purposes of accessing data sets in the cache, these data represent lower value data. Therefore, these data can be accessed at a slower rate.

This prioritizing of data in the data sets between key data, i.e., higher value data, and bulk data, i.e., lower value data, is application driven and is leveraged by the caching system of the present invention to divide the data sets between the fast access memory portion 241 of the cache 240 and the slow access memory portion 242 of the cache. When the fast access memory portion 241 has sufficient storage capacity, the caching system of the present invention holds the key data and bulk data of each data set in the fast access memory portion. As the capacity of the fast access memory portion is reached and additional data capacity is needed, the bulk data of one or more data sets are stored in only the slow access memory portion. The key data are always stored in the fast access memory portion, and the system includes a pointer to each memory location within the slow access memory portion containing bulk data stored in the slow access memory portion. Each pointer is stored in the fast access memory portion in combination with key data from the data set associated with the bulk data stored in the slow access memory portion. In one embodiment, the pointer is a location or address in memory that contains the bulk data. Preferably pointers include long pointers such as 64 bit pointers.

As illustrated, first key data 250 are associated with a first pointer 251 to first bulk data 252 located in the slow access memory portion 242. Second key data 260 are associated with a second pointer 261 to second bulk data 262 located in the slow access memory portion 242. Third key data 270 are associated with a third pointer 271 to third bulk data 272 located in the slow access memory portion 242. For these data sets, the bulk data are stored only in the slow access data portion. It is not required that all of the bulk data be moved or stored in the slow access memory portion. A sufficient amount of bulk data is stored in the slow access memory portion 242 to create a desired storage capacity in the fast access memory portion 241. Therefore, both the key data 280 and bulk data 282 of a given data set can be maintained in the fast access memory portion only. A plurality of entire data sets can be maintained in the fast access memory portion.

The caching system of the present invention facilitates faster access of cached data by the generating applications by always having the key data, i.e., the data referenced or called by the applications, in the fast access memory portion of the cache. Bulk data are contained in the fast access memory portion and the slow access memory portion. For bulk data in the slow access memory portion, pointers to these bulk data are used and stored in the fast access memory portion. The use of pointers facilitates access to the bulk data that has been moved, eliminates the possibility of duplicate copies of moved bulk data as the pointer points to a given location in the slow access memory portion and facilitates an asynchronous management of bulk data. To the applications, instructions for modification of bulk data are sent to the fast access memory portion references by the key data. The key data are immediately modified in the fast access memory location as appropriate in accordance with the instructions. In addition, acknowledgement is provided to the application that the instructions have been executed. However, the actual modifications to the bulk data are handled as resources permitted and not contemporaneously with the receipt of the instructions and acknowledgement of the completion of the instructions. Therefore, bulk data does not have to be returned to the fast access memory portion upon receipt of a given instruction.

Additional efficiency is accomplished by the system having copies of bulk data from the slow access memory portion in the fast access memory portion. As illustrated, a copy of the second bulk data 263 and a copy of the third bulk data 273 are provided in the fast access memory portion. These copies are provided without removing or deleting the corresponding bulk data in the slow access memory portion. Therefore, if no changes to the copies of the bulk data are made, then the copies do not have to be rewritten to the slow access memory portion. In addition, if additional space is required in the fast access memory portion, then the bulk data copies that have not been modified and are therefore identical to the bulk data in the slow access memory portion can simply be quickly deleted. In general, all of these operations are transparent to the distributed applications using the cache system, and these applications interact with the cache system as if the key data and bulk data of each data set are at all times stored in the fast access memory system.

Exemplary embodiments of the cache system in accordance with the present invention allocate the slow access memory portion in accordance with the application demand for data caching within the distributed computing system. This application-driven demand includes the number of data sets to be cached and the size of the data sets. In one embodiment, the slow access memory portion is a slab allocated memory portion. A discussion of slab allocation is found in Jeff Bonwick, “The Slab Allocator: An Object-Caching Kernel Memory Allocator”, USENIX Summer Technical Conference, pp. 87-98 (1994), which is incorporated herein by reference in its entirety. In general, a slab allocator allocates a given block of memory into a plurality of slabs or divisions, and each slab is further divided into a plurality of slots. The size of the divisions and slots is driven by the size of the data to be stored. In the cache system of the present invention, the slow access memory portion 242 includes at least one and preferably a plurality of divisions 300. Initially, the slow access memory system includes a single division taken or carved from the memory. The size of the division is selected to accommodate a reasonable number of the largest size of bulk data to be moved to and stored in the slow access data portion. For a largest bulk data size of 1 MB, a 10 MB division is taken from the slow access memory portion. As this first division fills with bulk data and additional storage is required, then additional additions are identified. In one embodiment, each division is of equal size.

Each division includes a plurality of equally sized slots 310. As with the divisions, the size of the slots is driven by the applications and the size of the data sets to be cached. In general, the size of the slots is selected to minimize any unused or wasted space within a given division. In one embodiment, the slots within a given division are each of equal size. This size can be chosen to equal the size of the bulk data to be moved to the slow access memory portion. When given bulk data exceed the size of the slots, the bulk data is written into two or more slots. Therefore, the size of the slots is selected to factor evenly into the size of the bulk data. This will eliminate or minimize left over capacity in any given slot. In one embodiment, the size of a given slot is selected to be a least common denominator of the size of any given bulk data to be moved to that division.

In one embodiment, additional divisions are created each of equal size and with an equal number and size of slots. This embodiment is consistent with bulk data that are of a generally consistent size or that represent multiples of a given amount of storage space. In order to accommodate a greater variety in the size of bulk data, the cache system includes a plurality of divisions 300 in the slow access memory portion where each division has a different number of slots, and each set of slots within a given division representing a different allocation of memory. Therefore, given bulk data 292 can be moved to an appropriately sized slot within one of the divisions. Varying the size of the slots within divisions of equal size yields a greater granularity in the size of bulk data than can be accommodated in the slow access memory portion while optimizing the overall storage capacity of the slow access memory portion. In one embodiment, the plurality of divisions 300 represents a sequence of equally sized divisions with increasing slot size. The slot size increases from division to division in the sequence such that the increase in slot size between slots in subsequent or adjacent divisions of the sequence comprises a certain predefined percentage increase.

In one embodiment, this predefined percentage increase is in a range of from about 5% to about 20%. Preferably, this predefined percentage increase is about a 10% increase. In general, bulk data stored in the slow access memory portion are located in an appropriately sized slot in one of the identified divisions.

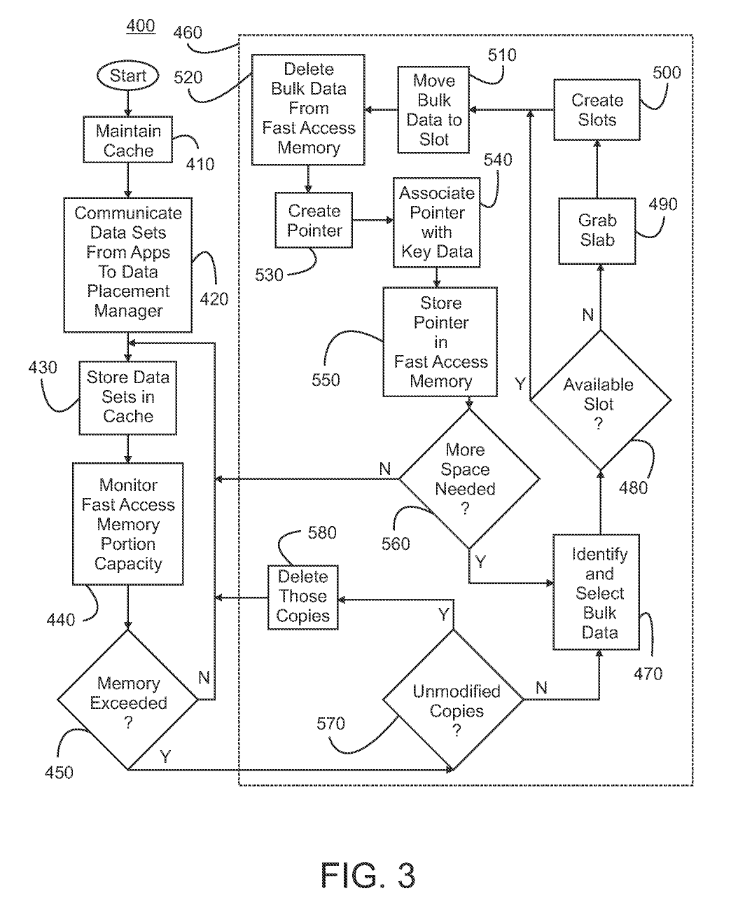

Referring to FIG. 3, a method for using the caching data 400 in accordance with exemplary embodiments of the present invention is illustrated. At least one cache is maintained 410 by a computing system. Suitable computing systems include single computers, computer networks and distributed computing systems. These computing systems can be disposed within a single domain or can span a plurality of domains. Suitable caches are as described herein and include a fast access memory portion and a slow access memory portion. The fast access memory portion includes volatile memory such as RAM. The slow access memory portion includes persistent durable memory such as a SSD. The cache has at least about 100 GB or preferably at least about 200 GB of storage capacity, and the size of the slow access memory portion is five times the size of the fast access memory portion.

At least one and preferably of a plurality of computer software applications, for example distributed applications, are instantiated and run within the computing system. These software applications generate data sets. These data sets include, but are not limited to, raw data, derivative data, data required by the applications during execution and work product of the applications. A given data set includes key data, e.g., meta-data, and bulk data. The key data of a given date set are defined by the application and used by the application to index and reference the data set. For example, the key data can be a filename, client name, a data of creation or a general subject category. The bulk data constitute the actual content of the data set that is used by the application. These data sets are communication from the applications to a data placement manager 420.

The application placement manager is in communication with the cache and stores a plurality of communicated data sets in the cache 430. Initially, both the key data and bulk data are stored in only the fast access memory portion of the cache. The application placement manager continues to place all data sets in the fast access memory portion of the cache. The capacity of the fast access memory portion is monitored 440. A determination is made regarding whether the capacity of the fast access memory portion is exceeded 450. If the capacity is not exceeded, then the data placement manager continues to store data sets in the fast memory portion of the cache. If the fast access memory portion of the cache is at or near capacity, then the storage capacity is created in the fast access memory portion 460.

Capacity is created in the fast access memory portion by moving or deleting data sets, and in particular the bulk data. In one embodiment, a given data set from the plurality of data sets stored in the fast access memory portion is identified 470. The bulk data of the identified data set is to be moved to the slow access memory portion. Preferably, the bulk data are moved to specific locations within the slow access memory portion so as to maximize the storage capacity of the slow access memory portion. In one embodiment, slab allocation is used to partition the slow access memory system so that bulk data can be moved to slots within the slabs or divisions defined in the slow access memory portion. Therefore, an initial determination is made regarding whether a slot is available within the slow access memory portion 480 in which to move the identified and selected bulk data. This determination includes determining whether a free slot exists and whether any existing free slot or combination of existing free slots is of sufficient size to accept the selected bulk data.

If an adequate slot does not exist, then a slot is created. In one embodiment, slab allocation is used to identify a division of slab of predetermined size in the slow access memory portion and to grab that slab for allocation to accept bulk data 490. The predetermined size for the identified division is selected to be sufficient to accommodate of plurality of copies of the bulk data. A plurality of slots 500 are then created in the division by dividing the identified division into a plurality of slots sized to accommodate a single copy of the bulk data. Having created a slot of proper size, or if a properly sized slot already existed, the bulk data are moved into the identified division and in particular into one of the slots 510. In addition to identifying a single division in the slow access memory portion, slab allocation is used to identify a plurality of divisions in the slow access memory portion and to divide each identified division into a plurality of equally sized slots. The selected bulk data are moved into an appropriately sized slot in one of the identified divisions. For example, the identified plurality of divisions can include a sequence of equally sized divisions such that slot size within a given division or slab increases from division to division in the sequence. This increase in slot size between slots in subsequent divisions of the sequence is preferably about a 10% increase, which provides the desired level of granularity to accommodate bulk data of varying sizes.

Only the bulk data of the identified and selected given data set are moved to the slot in the slow access memory portion. The key data remained in the fast access memory portion, and the bulk data are deleted from the fast access data portion 520, creating the desired additional storage space. A pointer to a memory location within the slow access memory portion containing the bulk data of the identified given data set is created 530. The pointer can be a long pointer such as a 64 Bit pointer. The pointer is associated with the appropriate key data 540, for example forming a set or tuple, and is stored in the fast access memory portion 550. Calls to the data set reference the key data and yield the pointer and access to the bulk data. A determination is made regarding whether additional storage is needed in the fast access memory portion 550. If more space is required, then additional data sets are identified and bulk data are selected for moving. If not, then the process returns to storing data sets in the fast access memory portion until the memory capacity is exceeded.

Applications gain access to the data sets stored in the cache by sending instructions or calls to the fast access memory portion. These calls contain the key data. If bulk data is required in the fast access memory portion, a copy of that bulk data, which is associated with an identified given data set, is retrieved from the slow access memory portion and is loaded into the fast access memory portion. The desired extraction and manipulation can then be performed on the bulk data copy. Any changes can ultimately be transferred to the bulk data in the slow access memory portion asynchronously with the changes to the copy. In one embodiment, the modified bulk data copy or the entire data set containing the bulk data copy is deleted before the modified copy is moved or required to be moved back to the slow access memory portion. For example, there may not be a need to reclaim memory from the fast access memory portion. Therefore, the modified bulk data copy is deleted before it is moved to the slow access memory portion. Even though a copy of the bulk data is made, the bulk data of the identified given data set in the slow access memory portion is maintained after the retrieval and loading of the copy of the bulk data of the identified given data set. Therefore, if no changes are made to the copy, then this copy, being identical to the maintained bulk data, is readily available for deletion in order to create additional storage space in the fast access memory portion. As shown in FIG. 3, for example, when the memory is exceeded, an initial determination is made regarding whether any unmodified copies of bulk data exist in the fast access memory portion 570. If such copies exist, they are deleted 580 to create additional storage space. If not, then the system proceeds to select bulk data to move to the slow access memory portion and to replace with an appropriate pointer.

In general, the arrangement and management of the cache, provide for quicker access of cached data sets by maintaining the appearance to each application that the entire data sets are maintained in the fast access memory portion and by providing asynchronous access to the slow access memory portion. In one embodiment, instructions are received from an application associated with an identified given data set. These instructions call for the modification of the identified data set. Such modifications include the deletion of the bulk data or the change of the bulk data. The application is provided with confirmation of completion of this modification. The bulk data of the identified given data set in the slow access memory portion is modified in accordance with the received instructions; however, this modification of the bulk data in the slow access memory portion occurs asynchronously with the steps of receiving the request and providing the application with confirmation.

In one embodiment, the application desires or requires modification of a data set having bulk data that resides in the slow access memory portion. The application provides the new bulk data containing the modified value or values to the cache. At this point, the new bulk data value exists in the fast access memory portion, because it was just processed into the system. The existing bulk data containing the original value or values do not have to be read from the slow access memory portion. The data set in the fast access memory portion is modified to remove the pointer to secondary storage location of the existing bulk data that is associated with the key data, including metadata, associated with the modified data set. The pointer is replaced with the new bulk data containing the modified value or values. The modified bulk data exist in the fast access memory portion. The now obsolete pointer to the slow access memory portion is placed on a work queue to be processed asynchronously. The work queue is processed asynchronously, and the pointer to the location of the existing bulk data in the slow access memory portion is used to access and to delete the now stale existing bulk data from the slow access memory portion. If it is determined at a later time that the modified bulk data need to be moved to the slow access memory portion the bulk data are moved to slow access memory portion. A new pointer is created to the new location of the bulk data, and the key data and metadata are updated to be associated with this pointer.

In accordance with exemplary embodiments of the present invention, a root data structure, i.e., the data placement manager, is used to decide where data sets are stored in the cache, volatile memory or durable memory. If located in the durable memory such as the SSD, a slab allocator is used to obtain and select a location in durable memory to place the bulk data of the data set. This location on disk is referenced in a pointer stored in the volatile memory in association with the key data portion of the data set. Therefore, the bulk data can be directly fetched from disk without indexing. Maintenance of key data and pointers in the volatile, fast access memory portion of the cache facilitates asynchronous updates and deletes, an in-memory representation, including the offset to the disk data, if any, of every cache entry and read optimization by keeping the disk copy in place while the bulk data is read into memory.

If the fast access memory portion becomes full, bulk data are flushed to disk. This is done asynchronously so that new insert and update operations are not slowed down by background disk activity. If insufficient memory is freed by the background process, the insert and update operations are blocked while memory is scavenged. A slab allocator allocates space on disk. In general, a slab allocator allocates fixed-sized entities. However, in one embodiment, a large number of slabs are allocated into slots from 1 k to 1 M bytes that are spaced by 10%, e.g., each successive slot 1.1 times the size: 1 k, 1.1 k. 1.21 K, . . . , 1 M. This yields an average wasted space of about 5% for uniform random sizing of bulk data.

Systems and methods in accordance with the present invention support asynchronous deletion. Data on disk is marked as deleted in memory and is actually cleaned off disk asynchronously in the background. Updating is performed asynchronously. An update operation on bulk data stored in disk does not have to wait. The in-memory state is updated and the disk state is reconciled later. Therefore, all insert, update and delete operations appear to the applications or users to be purely in memory operations, even if the entire data set does not fit in available memory. Insert operations are performed by storing the item into memory initially, while background processes move things to disk if necessary. The insert operation is not held up waiting for memory to be freed except in extreme load situations. Update operations are also performed by storing the new value in memory initially. If the old value had been offloaded to disk, a task is queued to clean up that disk space in the future. The user application does not wait for this to occur. Delete operations are also queued. If the value was offloaded to disk, the user application does not wait for the disk to be cleaned before receiving acknowledgement of the delete operation completion.

Systems and methods in accordance with the present invention also provide for read optimization. When bulk data are brought back into memory from disk, the bulk data remain on disk. If the item is offloaded again without being updated or deleted first, the offload operation has a minimal processing cost because the values are already on the disk. The duplicate disk copy is removed if the item is deleted. The item is updated so that the disk value would be stale or the disk capacity becomes limited at which point disk space that is being used by items that are also in memory are removed to eliminate redundancy.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment, the present invention is directed to a machine-readable or computer-readable storage medium containing a machine-executable or computer-executable code that when read by a machine or computer causes the machine or computer to perform a method for caching data in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for caching data, the method comprising:
maintaining a cache within a computing system, the cache comprising a fast access memory portion and a slow access memory portion;
storing a plurality of data sets in the fast access memory portion of the cache, each data set comprising key data and bulk data;
identifying a given data set from the plurality of data sets stored in the fast access memory portion to be moved to the slow access memory portion;
moving only the bulk data of the identified given data set to the slow access memory portion;
creating a pointer to a memory location within the slow access memory portion containing the bulk data of the identified given data set;
associating the pointer with the key data of the identified given data set; and
storing the pointer in the fast access memory portion.

2. The method of claim 1, wherein fast access memory portion comprises random access memory and the slow access memory portion comprises a solid state disk.

3. The method of claim 1, wherein the computing system comprises a distributed computing system, each data set comprises a data set generated by an application running within the distributed computing system and the key data of each data set is identified by the application generating that data set and is used by the application generating that data set to identify and to access that data set.

4. The method of claim 1, wherein the pointer comprises a long pointer comprising 64 bits.

5. The method of claim 1, wherein the key data comprise metadata.

6. The method of claim 1, wherein:
the method further comprises using slab allocation to identify a division of predetermined size in the slow access memory portion; and
the step of moving only the bulk data further comprises moving the bulk data into the identified division.

7. The method of claim 6, wherein:
the step of using slab allocation further comprises:
selecting the predetermined size for the identified division sufficient to accommodate of plurality of copies of the bulk data; and
dividing the identified division into a plurality of slots, each slot sized to accommodate a single copy of the bulk data; and.
the step of moving on the bulk data further comprises moving the bulk data into one of the slots.

8. The method of claim 1, wherein:
the method further comprises using slab allocation to identify a plurality of divisions in the slow access memory portion; and
dividing each identified division into a plurality of equally sized slots; and
the step of moving only the bulk data further comprises moving the bulk data into an appropriately sized slot in one of the identified divisions.

9. The method of claim 8, wherein the identified plurality of divisions comprises a sequence of equally sized divisions and slot size increases from division to division in the sequence such that the increase in slot size between slots in subsequent divisions of the sequence comprises about a predefined percentage increase.

10. The method of claim 1, wherein the method further comprises:
retrieving a copy of the bulk data of the identified given data set from the slow access memory portion;
loading the copy into the fast access memory portion; and
maintaining the bulk data of the identified given data set in the slow access memory portion after the retrieval and loading of the copy of the bulk data of the identified given data set.

11. The method of claim 3, wherein the method further comprises:
receiving instructions from the application associated with the identified given data set for modification of the identified data set;
providing the application with confirmation of completion of the modification; and
modifying the bulk data of the identified given data set in the slow access memory portion in accordance with the received instructions;
wherein the step of modifying the bulk data in the slow access memory portion occurs asynchronously with the steps of receiving the request and providing the application with confirmation.

12. The method of claim 11, wherein the instructions from the application for modification of the identified data set comprise a change in the bulk data or a deletion of the bulk data.

13. The method of claim 1, wherein the method further comprises:
moving the bulk data of each one of the plurality of data sets to the slow access memory portion;
retrieving a copy of the bulk data for each one of a plurality of the moved bulk data to the slow access memory;
loading each retrieved copy of the bulk data into the fast access memory portion;
detecting an insufficient amount of available memory in the fast access memory portion;
identifying copies of the bulk data in the fast access memory portion that are unmodified from the bulk data maintained in the slow access memory portion; and
deleting the identified unmodified copies of the bulk data from the fast access memory portion.

14. A method for caching data, the method comprising:
maintaining a cache within a computing system, the cache comprising a fast access memory portion and a slow access memory portion;
storing a plurality of data sets in the fast access memory portion of the cache, each data set comprising key data and bulk data;
moving only the bulk data for a subset of the plurality of stored data sets to the slow access memory portion;
receiving instructions from an application executing within the computing system and associated with one of the data sets within the subset of the plurality of stored data sets for modification of that data set;
providing the application with confirmation of completion of the request; and
modifying the bulk data of that data set in the slow access memory portion in accordance with the received instructions;
wherein the step of modifying the bulk data in the slow access memory portion occurs asynchronously with the steps of receiving the request and providing the application with confirmation.

15. The method of claim 14, wherein the instructions from the application for modification of that data set comprise a change in the bulk data or a deletion of the bulk data.

16. The method of claim 14, wherein the method further comprises:
retrieving a copy of the bulk data moved to the slow access memory for each data set in the subset of the plurality of stored data sets;
loading each retrieved copy of the bulk data into the fast access memory portion; and
maintaining the bulk data for each data set in the subset of the plurality of stored data sets in the slow access memory portion after the retrieval and loading of the copies of the bulk data.

17. The method of claim 16, wherein the method further comprises:
detecting an insufficient amount of available memory in the fast access memory portion;
identifying copies of the bulk data in the fast access memory portion that are unmodified from the bulk data maintained in the slow access memory portion; and
deleting the identified unmodified copies of the bulk data from the fast access memory portion.

18. The method of claim 14, wherein:
the method further comprises using slab allocation to identify divisions in the slow access memory portion; and
the step of moving only the bulk data further comprises moving the bulk data into the identified divisions.

19. The method of claim 18, wherein the identified divisions comprise a sequence of divisions where each division is of equal size and comprises a plurality of slots comprising sizes increasing from division to division in the sequence such that the increase in slot size between slots in subsequent divisions comprises a predefined percentage increase.

20. A system for caching data, the system comprising:
a cache in communication with a computing system, the cache comprising a fast access memory portion and a slow access memory portion;
a plurality of data sets in the fast access memory portion of the cache, each data set associated with an application running in the computing system and comprising key data and bulk data, wherein bulk data associated with at least one of the data sets are stored in the slow access memory portion and are removed from the fast access memory portion; and
a pointer to each memory location within the slow access memory portion containing bulk data stored in the slow access memory portion, each pointer stored in the fast access memory portion in combination with key data from the data set associated with the bulk data stored in the slow access memory portion.

21. The system of claim 20, wherein fast access memory portion comprises random access memory and the slow access memory portion comprises a solid state disk.

22. The system of claim 20, wherein:
the slow access memory portion comprises a plurality of divisions;
each division comprises a plurality of equally sized slots; and
bulk data stored in the slow access memory portion are located in an appropriately sized slot in one of the identified divisions.

23. The system of claim 22, wherein the plurality of divisions comprises a sequence of equally sized divisions and the slot size increases from division to division in the sequence such that the increase in slot size between slots in subsequent divisions of the sequence comprises a predefined percentage increase.

24. A computer-readable storage medium containing a computer-readable code that when read by a computer causes the computer to perform a method for contacting customers, the method comprising:
maintaining a cache within a computing system, the cache comprising a fast access memory portion and a slow access memory portion;
storing a plurality of data sets in the fast access memory portion of the cache, each data set comprising key data and bulk data;
identifying a given data set from the plurality of data sets stored in the fast access memory portion to be moved to the slow access memory portion;
moving only the bulk data of the identified given data set to the slow access memory portion;
creating a pointer to a memory location within the slow access memory portion containing the bulk data of the identified given data set;
associating the pointer with the key data of the identified given data set; and
storing the pointer in the fast access memory portion.

25. The computer readable storage medium of claim 24, wherein the method further comprises:
receiving instructions from an application running on the computing system and associated with the identified given data set for modification of the identified data set;
providing the application with confirmation of completion of the modification; and
modifying the bulk data of the identified given data set in the slow access memory portion in accordance with the received instructions;
wherein the step of modifying the bulk data in the slow access memory portion occurs asynchronously with the steps of receiving the request and providing the application with confirmation.
